(19) United States
(12) Patent Application Publication
(10) Pub. No.: US 2016/0044177 A1
(43) Pub. Date: Feb. 11, 2016

(54) AUTOMATIC PERSONALIZED OUTGOING MESSAGE DELIVERY RESPONSIVE TO UNANSWERED INCOMING AUDIO / VIDEO CALL

(71) Applicant: Ralph G. O'Brien, Old Bridge, NJ (US)

(72) Inventor: Ralph G. O'Brien, Old Bridge, NJ (US)

(21) Appl. No.: 14/817,012

(22) Filed: Aug. 3, 2015

Related U.S. Application Data
(60) Provisional application No. 62/033,956, filed on Aug. 6, 2014.

(51) Int. Cl. H04M 3/533

(52) U.S. Cl. CPC H04M 3/53383

(57) ABSTRACT

A system and a process for automatically providing an outgoing message in response to an unanswered incoming call are disclosed. The process includes providing one or more of an outgoing video message, an outgoing audio message, and an outgoing audio-visual message. In some embodiments, the process includes providing a personalized message in response to an unanswered incoming call. In some embodiments, a personalized message is based on at least one of a group profile and an individual profile. The process provides a personalized outgoing group message when a caller of an unanswered incoming call is associated with a particular group profile. The process provides a personalized outgoing individual message when a caller of an unanswered incoming call is associated with a particular individual profile.

### CLAIM OF BENEFIT TO PRIOR APPLICATION

This application claims benefit to U.S. Provisional Patent Application 62/033,956, entitled “PROCESS FOR AUTOMATICALLY PROVIDING AN OUTGOING MESSAGE IN RESPONSE TO AN UNANSWERED INCOMING CALL,” filed Aug. 6, 2014. The U.S. Provisional Patent Application 62/033,956 is incorporated herein by reference.

### BACKGROUND

Embodiments of the invention described in this specification relate generally to call messaging processes, and more particularly, to audio and video call messaging processes.

Call messaging processes and systems that currently exist provide a number of features for a caller to leave a message for a person whose call goes unanswered. For example, a caller may attempt to contact a colleague at work, but being unable to reach the colleague, may leave a voice mail message for the colleague.

Unfortunately, no processes, systems, and/or software currently exist that allow for personalized outgoing messages. For example, if a team leader cannot answer an incoming call from a team member but would like to inform the team member of an important team update, the team leader either has to record the important team update on a voice mail system that can be heard by any caller, whether or not a member of the team, or has to hope that a return call to the team member will be received by the team member in a timeframe suitable for the important team update. No such processes, systems, and/or software are implemented in either cloud-based or localized environments. This is problematic for people who need to provide personalized outgoing messages when a call is not answered.

Therefore, what is needed is a way to provide personalized outgoing messages when a call is not answered by a receiver.

### BRIEF DESCRIPTION

Some embodiments of the invention include processes for automatically providing a personalized outgoing message in response to an unanswered incoming audio and/or video call and at least one embodiment provides an automatic personalized outgoing message delivery system that is responsive to an unanswered incoming audio and/or video call. The personalized outgoing message is a pre-recorded, previously recorded, or otherwise created message prepared before the incoming audio and/or video call goes unanswered. The personalized outgoing message includes visual content, audible content, or combined audio-visual content. The content of the personalized outgoing message is an audio and/or video that is recorded or captured, or is a sequence of audio and/or video clips assembled together by way of an audio and/or video editor. The pre-recorded audio and/or video includes visual content and/or audio content. Hardware limitations are accommodated by delivering an audio-only message without the visual content of the pre-recorded video or a video-only message without the audio content of the pre-recorded video.

In some embodiments, the processes are implemented as software applications that run on a processor of a computing device. In some embodiments, the software applications run on a cloud-based computing device and provide messages from a cloud server that is accessible over a network.

In some embodiments, at least one process includes providing customized messages in response to unanswered incoming calls. In some embodiments, the customized messages are based on at least one of a group profile and an individual profile. In some embodiments, the process provides a customized outgoing group message when a caller of an unanswered incoming call is associated with a particular group profile. In some embodiments, the process provides a customized outgoing individual message when a caller of an unanswered incoming call is associated with a particular individual profile.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a process for automatically providing an outgoing message in response to an unanswered incoming call in some embodiments.

FIG. 2 conceptually illustrates a process for providing a customized outgoing message in response to an unanswered incoming call in some embodiments.

FIG. 3 conceptually illustrates a network architecture of a system that provides a pre-recorded outgoing video message responsive to an unanswered incoming call in some embodiments.

FIG. 4 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include processes for automatically providing a personalized outgoing message in response to an unanswered incoming audio and/or video call and at least one embodiment provides an automatic personalized outgoing message delivery system that is responsive to an unanswered incoming audio and/or video call. The personalized outgoing message is a pre-recorded, previously recorded, or otherwise created message prepared before the incoming audio and/or video call goes unanswered. The personalized outgoing message includes visual content, audible content, or combined audio-visual content. The content of the personalized outgoing message is an audio and/or video that is recorded or captured, or is a sequence of audio and/or video clips assembled together by way of an audio and/or video editor. The pre-recorded material includes visual content and/or audio content. Hardware limitations are accommodated by delivering an audio-only message without the visual content of the pre-recorded video or a video-only message without the audio content of the pre-recorded video.

In some embodiments, the processes are implemented as software applications that run on a processor of a computing device. In some embodiments, the software applications run on a cloud-based computing device and provide messages from a cloud server that is accessible over a network.

In some embodiments, at least one process includes providing customized messages in response to unanswered incoming calls. In some embodiments, the customized messages are based on at least one of a group profile and an individual profile. In some embodiments, the process provides a customized outgoing group message when a caller of an unanswered incoming call is associated with a particular group profile. In some embodiments, the process provides a customized outgoing individual message when a caller of an unanswered incoming call is associated with a particular individual profile.

The embodiments described in this specification differ from and improve upon currently existing options. In particular, some embodiments differ because existing call messaging systems and methods focus on caller-provided messaging, such as voice mail. In contrast, the processes and system of the present disclosure provide mechanisms for automatically sending an personalized outgoing message to a caller whose call goes unanswered by an intended or target call recipient. The personalized outgoing messages include pre-recorded video messages (with combined video and audio content), audio-only messages, and video-only messages. Furthermore, embodiments of the processes and the system described in this specification provide for local operation (e.g., a mobile device caller to mobile device receiver, where the receiver includes a locally stored message to send if a call from caller goes unanswered) and via cloud-network service (e.g., Internet-based application service through which a caller connects to make an audio and/or video call to receiver, but receiver does not answer, and cloud server sends pre-recorded outgoing message to caller on behalf of receiver). The methods, processes, and systems of existing schemes fail to provide the call receiver message transmission functionality of the methods, processes, and systems of the present disclosure.

In this specification, there are several descriptions of methods and processes that are performed by software running on a computing device (e.g., smartphone device of an unanswered call receiver, cloud server computing device, etc.). However, it should be noted that for the purposes of the embodiments described in this specification, the word “method” is used interchangeably with the word “process”. Methods performed by the software running on a computing device are described, therefore, by reference to several example processes that conceptually illustrate process steps for automatically providing a personalized outgoing message in response to an unanswered incoming audio and/or video call.

Several more detailed embodiments are described in the sections below. Section I conceptually describes a processes for automatically providing general and personalized outgoing messages in response to unanswered incoming calls. Section II describes a network architecture of a system that provides a pre-recorded outgoing audio and/or video message responsive to an unanswered incoming call. Section III describes an electronic system with which some embodiments of the invention are implemented.

I. Automatically Providing a Personalized Message Responsive to an Unanswered Incoming Audio and/or Video Call

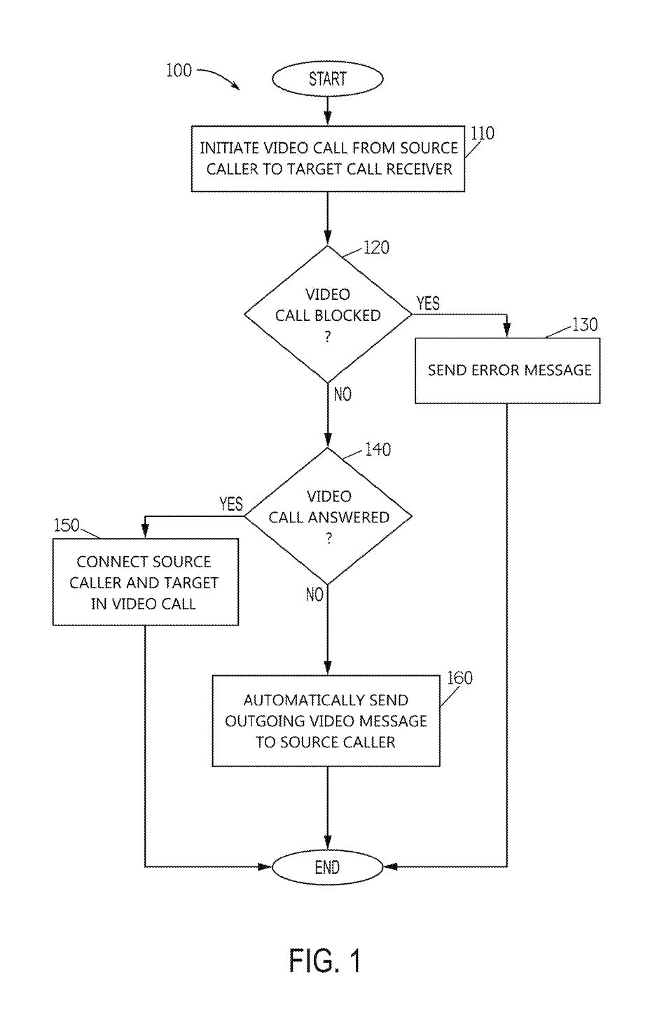

By way of example, FIG. 1 conceptually illustrates a process 100 for automatically providing an outgoing message in response to an unanswered incoming call in some embodiments. In some embodiments, the process 100 is performed by an audio-visual telecommunication software application. The audio-visual telecommunication software application runs on a computing device in a specific environment. In some embodiments, the environment is a cloud-based server and the audio-visual telecommunication software application includes a set of modules that form a service-oriented architecture for the software. In some embodiments, the audio-visual telecommunication software application provides a cloud service to a set of client telecommunication devices that connect to the cloud service over a public network, such as the Internet. In some embodiments, the audio-visual telecommunication software application provides a localized service to a set of client telecommunication devices that connect to the service over a private network.

As shown in FIG. 1, the process 100 starts when a source caller tries to make a call to someone at a destination (e.g., someone at work, someone in another state or country, etc.). In some cases, the call is a video call, but it may also be an audio call, or both video and audio call. The example illustrated in FIG. 1 is for a video call. While this an other examples described in this disclosure highlight aspects of delivery of a video message, a composite video with sequences of video images and corresponding audio (sound) content is within the scope of all of the embodiments and examples herein described. Indeed, recording one or more audio tracks and synchronizing the audio tracks to the video (e.g., at video capture time, after the video “images” or image sequences are captured during post-production, etc.).

Thus, a person skilled in the relevant art would understand that a video call does not preclude the existence of audio content throughout the video. Rather, one or more audio track(s) are typically associated with the video and synchronized to the video according to any of several well known techniques, such as synchronizing a timeline of video frames to timed moments of the audio content. Accordingly any video call made by the source caller and answered by a target call recipient (the intended receiving party/person or the “destination” of the video call) may include both audio and video. However, if one of the intended participants in the video call does not have sufficient video hardware, the audio still gets transmitted. Similarly, if no audio hardware, the video will nevertheless be transferred as intended for the video call.

Turning to the specific operations of the process 100, initiating (at 110) a video call occurs first. To initiate a video call, the source caller may use software to make a video call request to a particular party at a specific destination. For instance, the source caller may have a contact list associated with or saved in database in relation to the software application, thereby allowing the caller to quickly select a call receiver. In other cases, the source caller can input identifying user information for the intended target video call recipient (e.g., a user profile name, a unique identifier, etc.)

Next, the process 100 determines (at 120) whether the video call is blocked. In some cases, a video call initiated by a source caller will be automatically or manually blocked at the destination by the call receiver. For example, the call receiver previously put the source caller on do not call list or may have put all calls on hold (e.g., do not disturb). If the video call is blocked, the process sends (at 130) an error message related to the blocked call. The caller may try to connect the video call again later if so blocked, but in some cases, may need to communicate directly to the intended target video call recipient in order to have the party unblock video calls. In some embodiments, the software will automatically send a message to the intended target video call recipient party indicating that the source caller was blocked from making a video call connection to the target video call recipient party.

On the other hand, if the video call is not blocked, the process 100 then determines (at 140) whether the video call was answered by the receiver at the destination. If the receiving party answered the call, the process then connects (at 150) the call, allowing the audio-visual communication between the source caller and receiving party to go on. When they are finished with the call, they can initiate a hang-up which ends the process 100.

However, if the video call was not answered, the process 100 automatically sends (at 160) an outgoing message to the source caller from the intended target video call recipient party (e.g., the video call “destination” or “receiving party”). In some embodiments, the outgoing message is a pre-recorded video message. The pre-recorded video message may include audio and video message content that was recorded by a video capture device, such as a digital video camera or a mobile device with an on-board camera. The pre-recorded video message may include multiple pre-recorded video clips which have been edited and/or arranged along a timeline. For example, a target video call recipient may have prepared an outgoing message that includes textual video content with written instructions for doing something (e.g., the text is rendered to a video format) and scene-based video content with someone demonstrating how to do it.

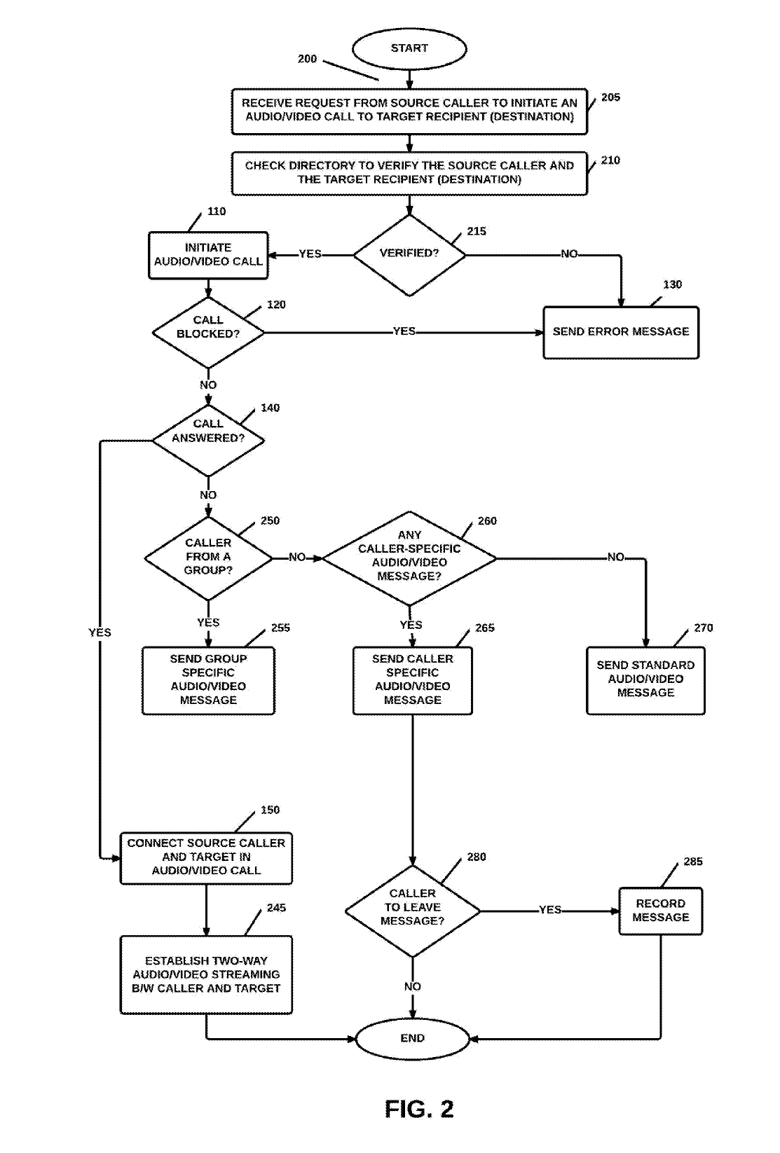

Outgoing messages can be tailored for different source callers. For example, the outgoing message may be a general message for any source caller whose audio and/or video call was not answered by the receiving party, or may be a specific message personalized for a particular group or individual. Personalized automated call messaging is further described by reference to FIG. 2, below. Also, in some embodiments, the process determines whether a call is answered by waiting a particular amount of time. For example, the software may be configured to ring five times before concluding that the call is not being answered.

Turning to FIG. 2, a process 200 is shown for providing a personalized outgoing message in response to an unanswered incoming audio and/or video call. The process 200 may be performed by a software application on a computing device (e.g., a computer server) that is accessible to other computing devices across a network (e.g., public networks such as the Internet, private networks such as a corporate local area network, etc.). When running on a processor of a computer server accessible over the Internet (a “cloud” server), the software application may provide a web service for making audio and/or video calls and for sending outgoing audio and/or video messages when a video call goes unanswered. The other computing devices include user computing devices operated by source callers to make audio and/or video calls and by target call recipients to participate in audio and/or video calls and to provide audio and video content to a source caller when unavailable to participate in a video call. Examples of a user computing device include, without limitation, a smartphone mobile device (“smartphone”), a tablet computing device (“tablet”), a laptop computer, a desktop computer, etc. The user computing devices may include audio and/or video call making software that allows users to record or select an outgoing audio and/or video message to upload to a database of the cloud server and to configure different settings related to each uploaded outgoing audio and/or video message.

As illustrated in this figure, the process 200 starts when a person (a “source caller”) initiates an audio and/or video call. For example, the source caller may open a software application which performs the process 200 and then selects an intended target recipient (or “destination” party) to which the audio and/or video call should be directed. Thus, the process 200 receives (at 205) a request from the source caller to initiate the audio and/or video call to the destination. As noted above, the type of call in this example is a audio/video call, but in some cases the call may be an audio-only call, or a video-only call.

Next, the process 200 checks (at 210) a directory to verify the source caller and receiving destination. For example, the software may check a look-up table for contacts registered to use the calling features or may retrieve records from a database to identify contact information of source and destination. Thus, the process 200 then determines (at 215) whether the source and destination are verified. If either of the source or destination cannot be verified, then the process sends (at 130) an error message indicating the problem. The caller may choose to re-initiate the call later, when the source and/or destination can be affirmatively verified. After sending the error message, the process ends.

On the other hand, when the process 200 is able to verify the source caller and destination receiver, the process 200 initiates (at 110) the audio and/or video call, which is described in greater detail above, by reference to FIG. 1. The process next determines (at 120) whether the call is blocked, which is also described by reference to FIG. 1 in greater detail. When a call is blocked, the process 200 sends (at 130) an error message, as described above.

When the process 200 determines (at 120) that the audio and/or video call is not blocked, the process then proceeds to the next step of determining (at 140) whether the audio and/or video call is answered, which is further described above by reference to FIG. 1. When the call is answered, the process 200 connects (at 150) the call, as described above by reference to FIG. 1. In some embodiments, the process 200 connects the audio and/or video call via an audio and/or video streaming protocol to allow for two-way streaming of the audio and/or video between the source and the destination. A person skilled in the relevant art would appreciate that the process 200 may be implemented in several different manners and that the type of audio and/or video transmission protocol used may depend on the implementation and hardware or network limitations existing for an audio and/or video call connection. Thus, while it is understood that an audio and/or video call connection can be made generally in any of several well-known real-time audio/video transmission protocols, the process 200 in this case establishes (at 245) two-way streaming of video (and audio, which may be embedded in the video stream, or may be time synchronized with the video at the receiving end of the stream when both the video is streamed and the audio is streamed separately).

As sometimes happens for any type of call, the audio and/or video call may not be answered by the receiving party. The process 200 may determine (at 140) that the audio and/or video call is not being answered after a threshold time has lapsed since starting the call, or after a pre-specified number of rings at the destination. While the steps of process 200 described above pertain mostly to establishing an audio and/or video call connection between a call initiator and a call recipient, several additional steps of process 200 relate to the responsiveness of the process 200 when an audio and/or video call goes unanswered. In other words, when the process 200 determines that the call is not answered, the process 200 performs steps related to providing for personalized messaging to be sent when the call is not answered. Specifically, when the process 200 determines (at 140) that the audio and/or video call has not been answered by the target video call recipient (or by anyone at the destination), the process tries to identify an appropriate outgoing message.

To identify a proper outgoing message, the process 200 of some embodiments first determines (at 250) whether the source caller is from a predefined group. In some cases, the software may compare the source caller's identifying information (e.g., video conferencing number, telephone number, user ID, screen name, email address, etc.) with a set of group identity data which includes group members. When the process 200 determines that the source caller is from a group, the process sends (at 255) a personalized group-specific outgoing message to the source caller. For example, the destination may be a group leader and a pre-recorded message may be sent to any member of the group whose call is not answered.

On the other hand, when the process 200 determines (at 250) that the source caller is not from a group, the process 200 then determines (at 260) whether there is a personalized pre-recorded audio and/or video message that is specifically intended for the source caller. For example, if the source caller is the intended destination party's brother, then a personalized pre-recorded message may have been recorded, created, and saved (for a subsequent use, e.g., automatically sending to the brother when the brother is the source caller whose audio and/or video call has gone unanswered) by the target audio and/or video call recipient. Thus, when the process determines that a personalized caller-specific outgoing video message for the source caller is available to transmit, the process 200 sends (at 265) the personalized caller-specific message.

On the other hand, when the process 200 determines (at 260) that the source caller is not associated with any previously recorded personalized caller-specific outgoing message, the process 200 of some embodiments uses a general pre-recorded outgoing audio and/or video message. In some embodiments, the general pre-recorded outgoing audio and/or video message is a standard or default outgoing message used in relation to source callers who are not associated with any personalized caller-specific pre-recorded messages and who are not in a common group with the target recipient.

Thus, in the event that the source caller is not determined to be a member of a group and no personalized caller-specific message exists in relation to this source caller, then the process 200 simply sends (at 270) the general pre-recorded message. This general message can be sent to all callers whose calls are not answered, unless the standard message is negated in favor of sending one of the more specific personalized messages (i.e., group-specific or individual caller-specific). Furthermore, a person skilled in the art would appreciate that group filtering and unique user filtering are just two of several possible qualities that can be implemented to refine the type of pre-recorded outgoing message that gets automatically sent when the call goes unanswered.

After the process 200 sends one of the messages (at 255, at 265, or at 270), the process then determines (at 280) whether the source caller wishes to send a message. For example, even when a source caller initiates an audio and/or video call with a target recipient, and the audio and/or video call goes unanswered by the target recipient, the source caller may record an audio and/or video message to deliver to the target recipient. When the source caller wants to send a message to the destination, the process 200 records (at 285) the message by the source caller and provides the recorded message to the destination. The process 200 then ends.

The processes described above by reference to FIGS. 1 and 2 provide ways in which automated messages (both standard and personalized) can be sent to a source caller when the source caller's video call request (or any call request) goes unanswered at a destination. Thus, the processes exemplify how video, audio, or audio-video information can be relayed to others even in the absence of an active call connection (e.g., in response to an unanswered call). In some cases, a caller with a mobile computing/communication device (e.g., a smartphone) and a target audio and/or video call recipient with a mobile computing/communication device can connect in an audio and/or video call. When the mobile computing/communication devices of the caller and the target audio and/or video call recipient have software installed implementing the processes 100 and 200, the mobile device of the target audio and/or video call recipient can have a pre-recorded outgoing audio and/or video message that is locally stored (e.g., in a database) on the mobile device, or on a non-transient removable data storage device/card, and which is automatically sent to the mobile device of the caller when the caller's audio and/or video call request goes unanswered. For example, the target audio and/or video call recipient may be occupied when the caller tries to connect in an audio and/or video call via the software, which thereby causes the software on the mobile device of the target audio and/or video call recipient to retrieve the pre-recorded outgoing audio and/or video message from the database (local data storage or removable storage media) and send the pre-recorded outgoing audio and/or video message to the mobile device of the caller for viewing/playback (e.g., via the software, or another program capable of playing audio and/or video).

In some other cases, the processes described above by reference to FIGS. 1 and 2 are implemented as software programs that run on a cloud server (or group of servers) and which provide a network-accessible service to audio and/or video callers and target audio and/or video call recipients.

In the next section, a network architecture of an outgoing message response system is described in which a cloud-network (e.g., Internet) system facilitates two-way streaming of audio and/or video calls between a source caller (or just “caller”) and a target audio and/or video call recipient (or just “call receiver”) when a connection can be established, but sends outgoing, pre-recorded audio and/or video messages from the target audio and/or video call recipient to the source caller when the target audio and/or video call recipient in unavailable.

### II. Automatic Outgoing Message Delivery Cloud Service

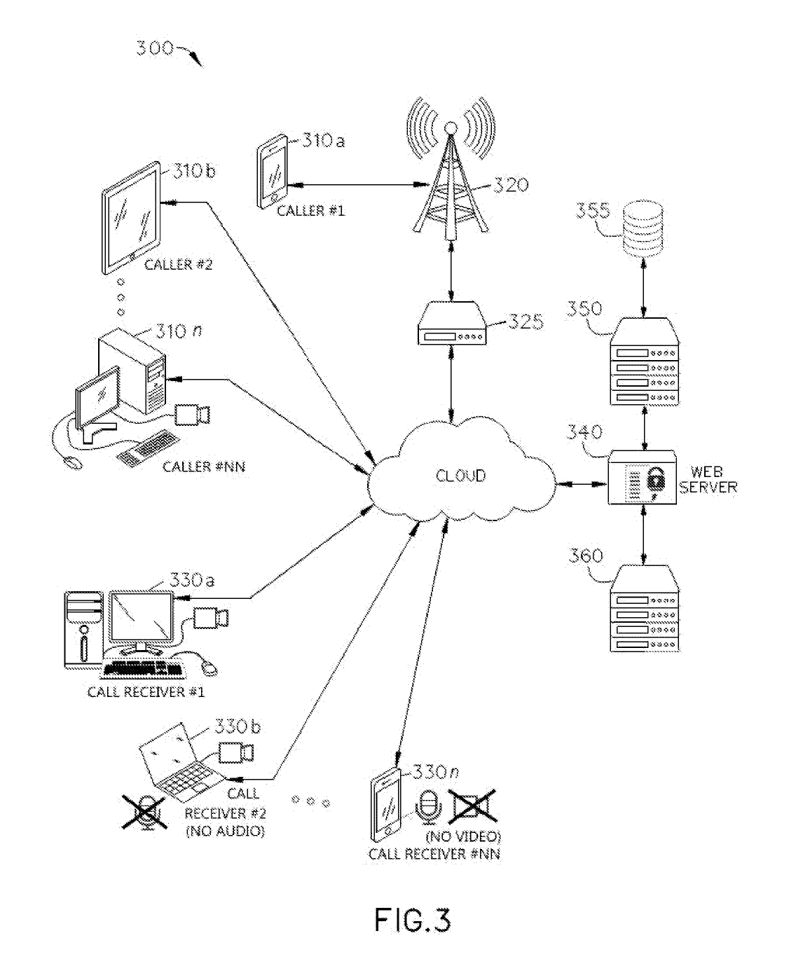

FIG. 3 conceptually illustrates a network architecture of a system 300 that provides a pre-recorded outgoing audio and/or video message responsive to an unanswered incoming call in some embodiments. As shown in this figure, the system 300 includes a first set of computing devices 310a-310n associated with a set of source callers (i.e., caller #1, caller #2, . . . , caller #nn), a second set of computing devices 330a-330n associated with a set of call receivers (i.e., call receiver #1, call receiver #2, . . . , call receiver #nn), a wireless communication point 320 (e.g., a cell tower for cellular data communication), a gateway 325, a web server 340, an outgoing message response server 350, an outgoing pre-recorded audio and/or video message database 355, and a group and user management system 360.

By way of example, when initiating an audio and/or video call, caller #1 uses a mobile computing device 310a to make a wireless connection to the wireless communication point 320. In order for the audio and/or video call to be useful, caller #1 would have provided appropriate identifying information for the target audio and/or video call recipient (e.g. a user ID, a unique identifier, etc.). The identifying information and a request to connect the target recipient in the audio and/or video call get transferred to the gateway 325 for access to the “cloud” network (e.g., Internet).

Similarly, caller #2 may use a tablet computing device 310b to establish a two-way audio and/or video call with a call receiver. In this case, the tablet computing device 310b is connected to the “cloud” network by way of a network transmission protocol, such as Internet Protocol (IP). The tablet computing device 310b may connect to a local router by a wireless connection, such as WiFi, but in this example does not direct traffic through the wireless communication point 320.

The outgoing message response system 300 of some embodiments is highly scalable, being able to support multiple connections from multiple callers and can simultaneously support ongoing two-way streamed audio and/or video calls while also identifying, retrieving (from database), and sending pre-recorded outgoing audio and/or video messages in response to unanswered calls. In some embodiments, the scalability of the outgoing message response system 300 is due to having more than one outgoing message response server 350. In the example of FIG. 3, multiple redundant outgoing message response servers 350 are shown in stacked form. In some embodiments, the redundancy configuration allows additional outgoing message response servers 350 to be added. Additionally, the outgoing pre-recorded audio and/or video message database 355 in some embodiments includes multiple databases 355 that may be logically connected while being physically separate.

Thus, the example outgoing message response system 300 shown in this figure includes caller #NN, signifying possible contemporaneous connections from other callers. As shown, caller #NN uses a desktop computer 310n with a video camera connected (e.g., a web cam).

The call receivers associated with second set of computing devices 330a-330n include call receiver #1 using a desktop computer 330a with an attached camera and an existing audio system (not shown), call receiver #2 using a laptop computer 330b that has a video camera but no audio (the audio is either non-existent or disabled/unavailable), and call receiver #nn) using a mobile computing device 330n with an audio system but no video capabilities (no camera or disabled).

Each of the call receivers may have used their devices to record an outgoing message to be used in the event that an audio and/or video call from a caller goes unanswered. For instance, call receiver #1 may record a general default audio and/or video message and a user-specific audio and/or video message (e.g., a video message to deliver to only caller #2 in the event that caller #2 initiates a video call with call receiver #1 but the video call goes unanswered). Call receiver #2, not having an audio system to use, may record a video-only message to deliver generally. Call receiver #NN may record audio content (e.g., a spoken dialogue) to deliver generally when incoming video call requests go unanswered.

Each pre-recorded outgoing audio and/or video message is uploaded to the outgoing message response server 350 to be stored in the outgoing pre-recorded audio and/or video message database 335 for subsequent retrieval. The web server 340 may require call receivers to logon before granting access to the outgoing message response server 350. For instance, the web server 340 may require a set of authentication credentials (e.g., username and password) and then may grant access (via one or more uploading tools, access tools, configuration tools, and settings tools) to the outgoing message response server 350 and outgoing pre-recorded audio and/or video message database 355 in which to store the pre-recorded outgoing audio and/or video messages.

Settings and configurations can be made in the group and user management system 360. For example, call receiver #1 may set up a user-specific configuration associated with a particular audio and/or video message to deliver to only caller #2 in the event that caller #2 initiates an audio and/or video call with call receiver #1 but the audio and/or video call goes unanswered.

It should be noted that any caller can also be a call receiver depending upon the initialization point of an audio and/or video call. For instance, the computing device 330a could be used to initiate an audio and/or video call (thereby re-characterizing call receiver #1 as a caller). Similarly, computing devices 330b and 330n could be used to initiate audio and/or video calls. However, in the event that an audio and/or video call request from computing device 330b went unanswered, the outgoing message response server 350 may provide a video-only version of a pre-recorded outgoing audio/video message based on the audio hardware limitation of computing device 330b. Also, in the event that an audio/video call request from computing device 330n went unanswered, the outgoing message response server 350 may provide an audio-only version of a pre-recorded outgoing audio/video message based on the video hardware limitation of computing device 330n (that is, if the video hardware limitation is related to the display of a video message on

### III. Electronic System

Many of the above-described processes, modules, features, and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

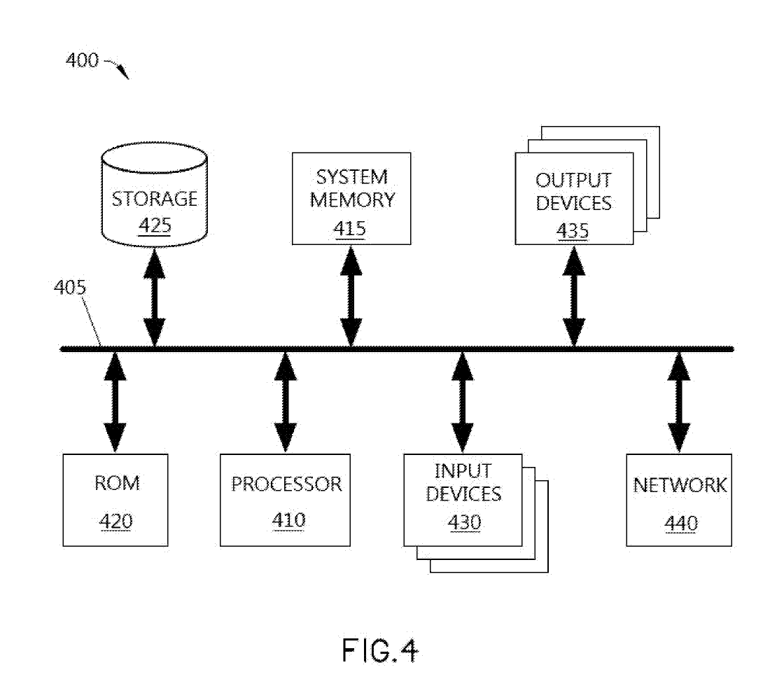

FIG. 4 conceptually illustrates an electronic system 400 with which some embodiments of the invention are implemented. The electronic system 400 may be a computer, phone, PDA, or any other sort of electronic device. Such an electronic system includes various types of computer readable media and interfaces for various other types of computer readable media. Electronic system 400 includes a bus 405, processing unit(s) 410, a system memory 415, a read-only 420, a permanent storage device 425, input devices 430, output devices 435, and a network 440.

The bus 405 collectively represents all system, peripheral, and chipset buses that communicatively connect the numerous internal devices of the electronic system 400. For instance, the bus 405 communicatively connects the processing unit(s) 410 with the read-only 420, the system memory 415, and the permanent storage device 425.

From these various memory units, the processing unit(s) 410 retrieves instructions to execute and data to process in order to execute the processes of the invention. The processing unit(s) may be a single processor or a multi-core processor in different embodiments.

The read-only-memory (ROM) 420 stores static data and instructions that are needed by the processing unit(s) 410 and other modules of the electronic system. The permanent storage device 425, on the other hand, is a read-and-write memory device. This device is a non-volatile memory unit that stores instructions and data even when the electronic system 400 is off. Some embodiments of the invention use a mass-storage device (such as a magnetic or optical disk and its corresponding disk drive) as the permanent storage device 425.

Other embodiments use a removable storage device (such as a floppy disk or a flash drive) as the permanent storage device 425. Like the permanent storage device 425, the system memory 415 is a read-and-write memory device. However, unlike storage device 425, the system memory 415 is a volatile read-and-write memory, such as a random access memory. The system memory 415 stores some of the instructions and data that the processor needs at runtime. In some embodiments, the invention's processes are stored in the system memory 415, the permanent storage device 425, and/or the read-only 420. For example, the various memory units include instructions for processing appearance alterations of displayable characters in accordance with some embodiments. From these various memory units, the processing unit(s) 410 retrieves instructions to execute and data to process in order to execute the processes of some embodiments.

The bus 405 also connects to the input and output devices 430 and 435. The input devices enable the user to communicate information and select commands to the electronic system. The input devices 430 include alphanumeric keyboards and pointing devices (also called “cursor control devices”). The output devices 435 display images generated by the electronic system 400. The output devices 435 include printers and display devices, such as cathode ray tubes (CRT) or liquid crystal displays (LCD). Some embodiments include devices such as a touchscreen that functions as both input and output devices.

Finally, as shown in FIG. 4, bus 405 also couples electronic system 400 to a network 440 through a network adapter (not shown). In this manner, the computer can be a part of a network of computers (such as a local area network (“LAN”), a wide area network (“WAN”), or an intranet), or a network of networks (such as the Internet). Any or all components of electronic system 400 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 1-2 conceptually illustrate processes. The specific operations of each process may not be performed in the exact order shown and described. Specific operations may not be performed in one continuous series of operations, and different specific operations may be performed in different embodiments. Furthermore, each process could be implemented using several sub-processes, or as part of a larger macro process. Thus, one of ordinary skill in the art would understand that the invention is not to be limited by the foregoing illustrative details, but rather is to be defined by the appended claims.

I claim:

1. A non-transitory computer readable medium storing a program which when executed by at least one processing unit of a computing device automatically provides an outgoing message to a source caller in response to an unanswered incoming call by a destination receiver, said program comprising sets of instructions for:
initiating an audio and/or video call by a source caller to a destination receiver;
determining whether the audio and/or video call is blocked at the destination;
when the audio and/or video call is determined to be blocked, sending an error message to the source caller;
when the audio and/or video call is determined not to be blocked, determining whether the audio and/or video call is answered at the destination;
when the audio and/or video call is determined to be answered at the destination, connecting the audio and/or video call between the source caller and the destination receiver; and
when the audio and/or video call is determined not to be answered, automatically sending an outgoing audio and/or video message to the source caller.

2. The non-transitory computer readable medium of claim 1, wherein the outgoing audio and/or video message is a pre-recorded audio and/or video message by the destination receiver.

3. The non-transitory computer readable medium of claim 1, wherein the program further comprises sets of instructions for:
receiving a selection of the destination receiver from a list of possible call receivers, said selection of the destination receiver from a local list of contacts; and
checking a database to verify authenticity of the destination receiver.

4. The non-transitory computer readable medium of claim 1, wherein the set of instructions for automatically sending the outgoing audio and/or video message to the source caller comprises a set of instructions for determining whether the source caller is associated with a particular group.

5. The non-transitory computer readable medium of claim 4, wherein the outgoing audio and/or video message is a personalized group outgoing audio and/or video message, wherein the set of instructions for automatically sending the outgoing audio and/or video message to the source caller comprises a set of instructions for retrieving the personalized group outgoing audio and/or video message.

6. The non-transitory computer readable medium of claim 1, wherein the set of instructions for automatically sending the outgoing audio and/or video message to the source caller comprises a set of instructions for determining whether the destination receiver has pre-recorded a personalized user-specific outgoing audio and/or video message associated with the source caller.

7. The non-transitory computer readable medium of claim 6, wherein the outgoing audio and/or video message is a user-specific outgoing audio and/or video message, wherein the set of instructions for automatically sending the outgoing audio and/or video message to the source caller comprises a set of instructions for retrieving the personalized user-specific outgoing audio and/or video message.

8. An automatic outgoing message delivery system that is responsive to an unanswered incoming audio and/or video call, said system comprising:
a source caller computing device comprising a processor, a memory unit, a display screen, an audio/video camera, and a two-way streaming audio/video call application which when running on the processor initiates an audio/video call to connect with a target audio/video call recipient in an audio/video call;
a cloud server computing device comprising a server processor, a server memory unit, and a responsive message delivery program which when running on the server processor determines whether the audio/video call to connect with the target audio/video call recipient if a audio/video call is answered, wherein when the audio/video call is not answered, the responsive message delivery program retrieves an outgoing message associated with the target audio/video call recipient and sends the outgoing message to the source caller; and
a target call recipient computing device comprising a recipient processor, a recipient memory unit, a recipient display screen, a recipient video camera, and a set of outgoing message uploading tools that allow the target audio and/or video call recipient to upload a pre-recorded outgoing audio and/or video message to the cloud server computing device to be transmitted to the source caller when the audio and/or video call goes unanswered.

9. The automatic outgoing message delivery system of claim 8, further comprising an outgoing audio and/or video message database capable of storing a plurality of pre-recorded outgoing audio and/or video messages, a plurality of configuration records related to general and personalized outgoing video messages, and a plurality of relationship records that associate the plurality of configuration records to the plurality of pre-recorded outgoing audio and/or video messages.

10. The automatic outgoing message delivery system of claim 9, wherein the cloud server computing device retrieves a particular pre-recorded outgoing audio and/or video message from the outgoing audio and/or video message database when a audio and/or video call initiated by the source caller goes unanswered by the target video call recipient.
